(19) United States
(12) Patent Application Publication
(10) Pub. No.: US 2004/0177731 A1
(43) Pub. Date: Sep. 16, 2004

(54) Tool having rotatable driving member

(76) Inventor: Chia Yu Chen, Taichung (TW)

Correspondence Address: CHARLES E. BAXLEY, ESQUIRE, 59 John Street, Fifth Floor, New York, NY, 10038, US

(21) Appl. No.: 10/385,276

(22) Filed: Mar. 10, 2003

(51) Int. Cl. B25B 23/16

(52) U.S. Cl. 81/177.8

(57) ABSTRACT

A tool includes a shank having an orifice and two flaps, and an aperture communicated with the orifice. A driving member includes a number of depressions and teeth formed on a projection. A ball is received in the aperture of the shank, and engageable into either of the depressions of the driving member. A button is received in the orifice of the shank, and includes a groove to receive the ball, and to allow the ball to be disengaged from the depressions and the teeth of the driving member. A spring may bias the button to force the ball to engage into either of the depressions of the driving member, and to lock the driving member to the shank at selected angular positions.

### BACKGROUND OF THE INVENTION

1. Field of the Invention

The present invention relates to a tool, and more particularly to a tool having a locking device to selectively lock a rotatable driving member to a handle.

2. Description of the Prior Art

Various kinds of typical tools may comprise a rotatable driving member to be selectively locked to a handle with a locking device. For example, U.S. Pat. No. 4,463,632 to Parke discloses one of the typical tools comprising a locking device to selectively lock a rotatable driving member to a handle. The locking device includes a lock bar slid ably received in the driving member, and a spring biased lock pin slid ably received in the lock bar for forcing a ball to engage with the driving member. However, when the spring biased lock pin is engaged with the ball, the ball may also be easily forced to be moved against the lock pin when the driving member is rotated relative to the handle, such that the driving member may not be solidly secured to the handle at the required angular position.

U.S. Pat. No. 4,711,145 to Inoue discloses another typical tool comprising a moving part to selectively lock a rotatable driving member to a handle, and additionally, an operation rod is further required to be engaged in the handle and threaded with the moving part, in order to move the moving part toward or away from the driving member, in order to solidly secure the driving member to the handle at the required angular position. However, a number of parts or elements are required to be manufactured and assembled, such that the manufacturing cost of the tool is greatly increased.

U.S. Pat. No. 6,000,302 to Chiang discloses a further tool having a rotatable driving member to be rotatably secured to a handle with a pawl and a button. The pawl includes one enlarged end to engage with the driving member, and a rod to be engaged with the button. The button includes a recess and a tapered surface for engaging with the rod of the pawl. However, the button should be precisely assembled into the handle for directing the recess thereof toward the rod of the pawl, for allowing the button to actuate onto the rod of the pawl. It will thus be difficult to assemble the pawl and the button to the handle and the rotatable driving member.

The present invention has arisen to mitigate and/or obviate the afore-described disadvantages of the conventional tools.

### SUMMARY OF THE INVENTION

The primary objective of the present invention is to provide a tool including a simplified locking device to selectively and solidly lock a rotatable driving member to a handle.

The other objective of the present invention is to provide a tool including fewer elements or parts that may be easily assembled into the handle or the rotatable driving member.

In accordance with one aspect of the invention, there is provided a tool comprising a shank including a first end having an orifice and a notch formed therein, and including a pair of flaps provided on the first end thereof to define the notch between the flaps, and including an aperture formed therein and communicating between the orifice and the notch thereof, a driving member including a projection extended therefrom and engageable into the notch of the shank, and including a plurality of depressions and teeth formed on an outer peripheral portion of the projection, a ball slid ably received in the aperture of the shank, and engageable into either of the depressions of the driving member, a button slid ably received in the orifice of the shank, and including an outer end extendible out of the orifice of the shank, and including an inner end received in the orifice of the shank, and including a middle portion having an annular groove formed therein to selectively receive the ball and to allow the ball to be disengaged from the depressions and the teeth of the driving member. A spring biasing device is further provided for biasing the outer end of the button out of the orifice of the shank, and simultaneously to disengage the ball from the annular groove of the button, and simultaneously to force the inner end of the button to engage with the ball, and to force the ball to engage into either of the depressions of the driving member, and to lock the driving member to the shank at selected angular positions. The tool includes a simplified locking device to selectively and solidly lock a rotatable driving member to a handle at any selected angular position, and having fewer elements or parts that may be easily assembled into the handle or the rotatable driving member.

The button includes an inclined peripheral surface formed in the inner end thereof, and located beside the annular groove thereof, to facilitate a movement of the ball from the annular groove of the button onto the inner end of the button.

The shank includes a peripheral shoulder formed in the orifice thereof, the button includes a peripheral flange extended radially out from the inner end thereof, to engage with the annular shoulder of the shank, and to limit a movement of the button relative to the shank, and to prevent the button from being disengaged from the shank.

The shank includes an end cap to enclose a first end of the orifice of the shank, and the biasing device includes a spring member biased between the end cap of the shank and the button, to bias the outer end of the button out of the orifice of the shank.

The spring member includes a first end having a greater diameter and engaged with the end cap of the shank, and a second end having a smaller diameter and engaged with the button. The button includes a cavity formed in the inner end thereof to partially receive the spring member.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a perspective view of a tool in accordance with the present invention;

FIG. 2 is a partial exploded view of the tool;

FIG. 3 is a partial cross sectional view taken along lines 3-3 of FIG. 1;

FIG. 4 is a partial cross sectional view similar to FIG. 3, illustrating the operation of the tool;

FIG. 5 is a perspective view illustrating the other arrangement or application of the tool; and

FIG. 6 is a perspective view illustrating the a further arrangement or application of the tool.

### DETAILED DESCRIPTION OF THE PREFERRED EMBODIMENT

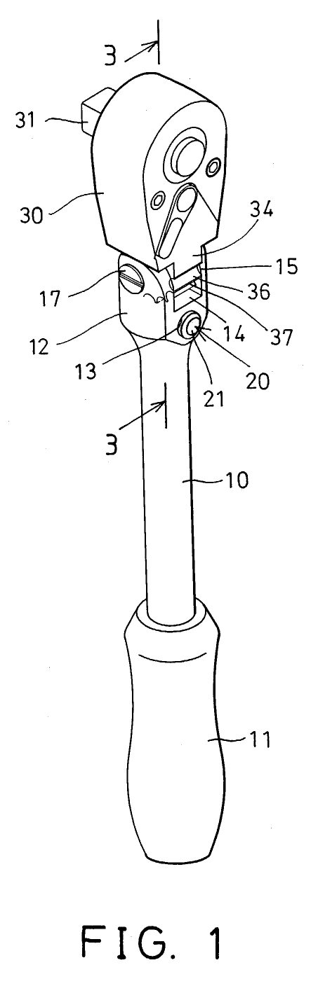

Referring to the drawings, and initially to FIGS. 1-3, a tool in accordance with the present invention comprises a shank 10 including a handle 11 formed or provided on one end thereof, and including another end 12 having an orifice 13 and a notch 14 formed therein and separated from each other, and having two flaps 15 formed or extended therefrom to form or define the notch 14 between the flaps 15, and to form a fork-shaped configuration.

For example, the flaps 15 may each include a hole 16 formed therein to receive a fastener or a shaft 17 therein, in which the shaft 17 is engaged through the notch 14 of the shank 10 and may be secured to the flaps 15 by such as threading engagements. An aperture 18 is formed in the end 12 of the shank 10 to communicate the orifice 13 and the notch 14 of the shank 10 with each other. The shank 10 may include an end cap 19 formed or attached thereto to enclose one end of the orifice 13 and to form a blind orifice 13.

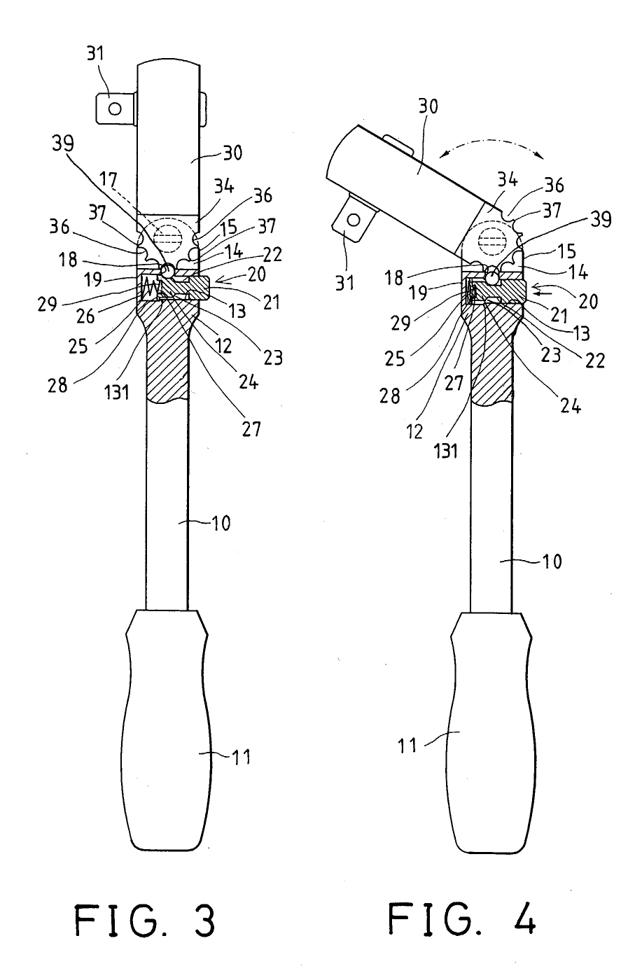

A button 20 is slid ably received in the orifice 13 of the shank 10, and includes one end or an outer end 21 extendible out of the orifice 13 of the shank 10 (FIGS. 1, 3), and includes an annular groove 22 formed in the middle portion thereof, and an inclined peripheral surface 23 formed therein, such as formed in the other or inner end 24 thereof, and located beside the annular groove 22 thereof. The button 20 includes a peripheral flange 28 extended radially out from the inner end 24 thereof.

As best shown in FIGS. 3 and 4, the shank 10 includes a peripheral bulge or peripheral shoulder 131 formed or provided in the middle portion of the orifice 13 thereof, to receive or to engage with the peripheral flange 28 of the button 20 (FIG. 3). Or, relatively, the peripheral flange 28 of the button 20 may engage with the peripheral bulge or peripheral shoulder 131 of the shank 10 in order to limit the relative movement between the button 20 and the shank 10, and so as to prevent the button 20 from being disengaged from the shank 10.

While assembling, the button 20 may first be engaged into the orifice 13 of the shank 10, and the end cap 19 is then engaged into one end of the orifice 13 of the shank 10, in order to enclose or to block the one end of the orifice 13 of the shank 10, and thus to prevent the button 20 from being disengaged from the shank 10. A spring member 25 may be provided and engaged between the button 20 and the shank 10, in order to bias the outer end 21 of the button 20 out of the orifice 13 of the shank 10.

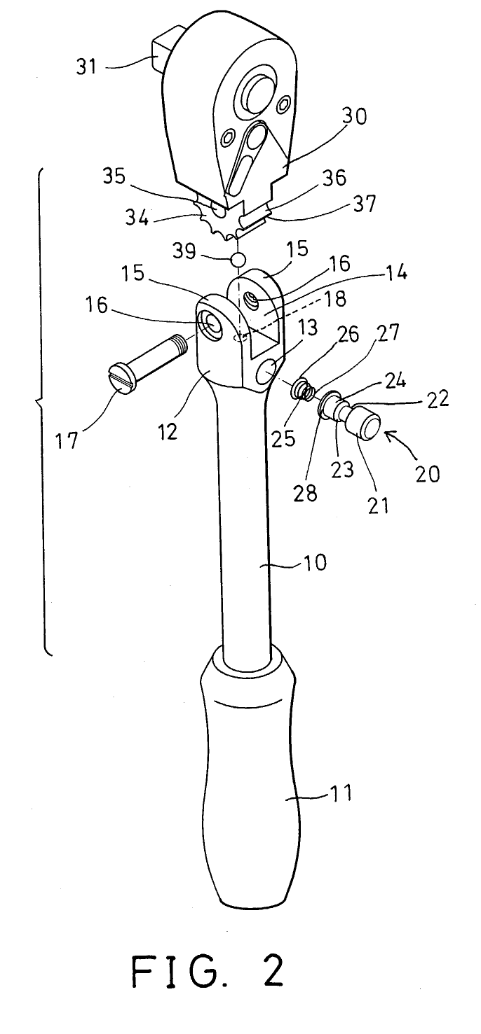

As shown in FIGS. 2-4, it is preferable that the spring member 25 includes one end 26 having a greater diameter to engage with the end cap 19 of the shank 10, and the other end 27 having a smaller diameter to engage into a cavity 29 that is formed in the inner end 24 of the button 20. The spring member 25 may thus be stably engaged or biased between the button 20 and the shank 10, and may thus stably bias the outer end 21 of the button 20 out of the orifice 13 of the shank 10.

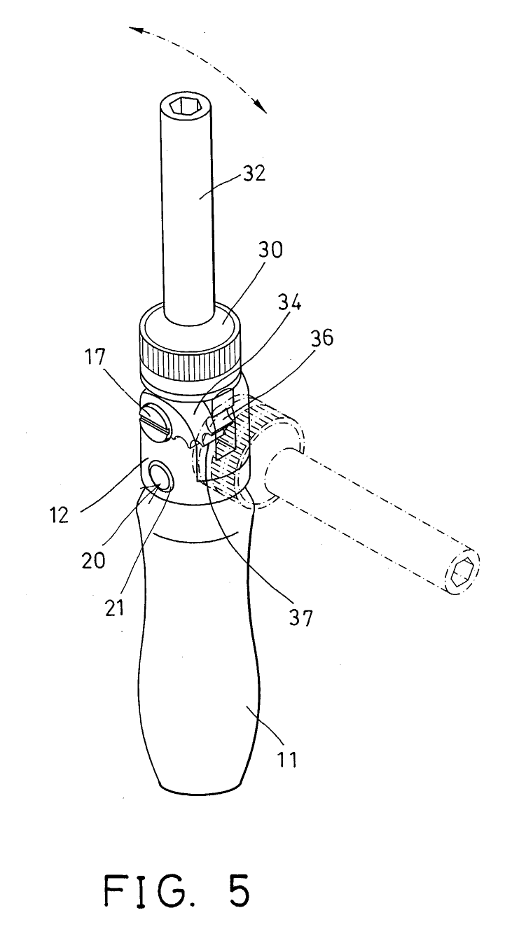

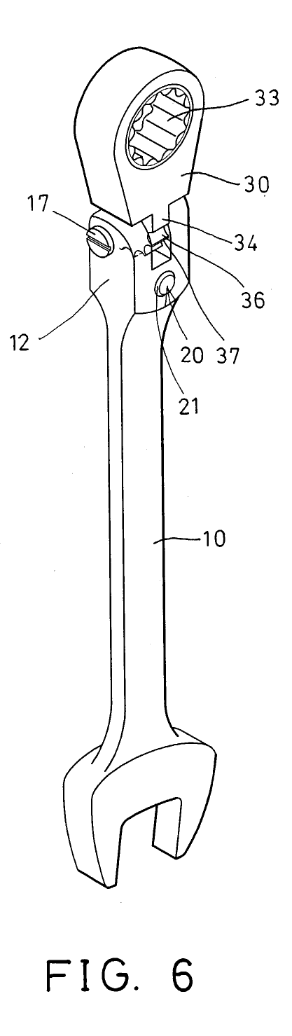

A driving member 30 includes a driving stem 31 (FIGS. 1-4) provided thereon.for engaging with or for driving fasteners, tool extensions, or the like. Alternatively, as shown in FIG. 5, the driving member 30 may include a socket extension 33 to engage with and to drive fasteners, tool extensions, or the like. Further alternatively, as shown in FIG. 6, the driving member 30 may include a female ratchet driving member 33 to engage with and to drive fasteners, tool extensions, or the like.

Referring again to FIGS. 1-4, the driving member 30 includes a projection 34 extended therefrom and engageable into the notch 14 of the shank 10, and having an opening 35 formed therein to receive the shaft 17 therein, such that the driving member 30 may be rotatably secured to the end 12 of the shank 10 with the shaft 17. The driving member 30 includes a number of curved depressions 36 and teeth 37 alternatively formed on the outer peripheral portion of the projection 34.

As shown in FIGS. 2-4, a ball 39 is slid ably received in the aperture 18 of the shank 10, and engageable with either of the curved depressions 36 of the driving member 30, and receivable in the annular groove 22 of the button 20. As shown in FIG. 4, when the ball 39 is received in the annular groove 22 of the button 20, the ball 39 may be disengaged from the curved depressions 36 and/or the teeth 37 of the driving member 30. At this moment, the driving member 30 is freely rotatable relative to the shank 10 about the shaft 17.

As shown in FIG. 3, the spring member 25 may bias the button 20, to force the outer end 21 of the button 20 out of the orifice 13 of the shank 10, and may bias the inner end 24 of the button 20 to engage with the ball 39. At this moment, the ball 39 may be forced to engage into either of the curved depressions 36 of the driving member 30 by the inner end 24 of the button 20, in order to lock the driving member 30 to the shank 10 at the required or selected angular position.

When it is required to rotate or adjust the driving member 30 relative to the shank 10 again, it is only required to depress the button 20 into the orifice 13 of the shank 10 against the spring member 25, and to receive the ball 39 in the annular groove 22 of the button 20, in order to disengage the ball 39 from the curved depressions 36 and/or the teeth 37 of the driving member 30 (FIG. 4), and thus for allowing the driving member 30 to freely rotate relative to the shank 10.

When the button 20 is released, the spring 25 may bias the button 20 away from the end cap 19, and the ball 39 may be moved from the annular groove 22 toward the inner end 24 of the button 20 via the inclined peripheral surface 23 of the button 20; i.e., the inclined peripheral surface 23 of the button 20 allows the ball 39 to be smoothly and easily moved from the annular groove 22 toward the inner end 24 of the button 20 when the button 20 is biased away from the end cap 19 or when the outer end 21 of the button 20 is biased out of the shank 10 by the spring 25.

It is to be noted that the ball 39 may be received in the annular groove 22 of the button 20 even when the button 20 is rotated relative to the shank 10. Accordingly, it is not necessarily to accurately align or position the button 20 relative to the shank 10, and the button 20 may thus be easily and quickly engaged into the orifice 13 of the shank 10. The ball 39 may then be easily engaged into the aperture 18 of the shank 10, and the driving member 30 may then be easily secured to the shank 10 with the shaft 17.

It is preferable that the ball 39 be engaged in either of the curved depressions 36 of the driving member 30, and received in the annular groove 22 of the button 20 while securing the driving member 30 to the shank 10 with the shaft 17.

Accordingly, the tool in accordance with the present invention includes a simplified locking device to selectively and solidly lock a rotatable driving member to a handle at any selected angular position, and having fewer elements or parts that may be easily assembled into the handle or the rotatable driving member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool comprising:
a shank including a first end having an orifice and a notch formed therein, and including a pair of flaps provided on said first end thereof to define said notch between said flaps, and including an aperture formed therein and communicating between said orifice and said notch thereof,
a driving member including a projection extended therefrom and engageable into said notch of said shank, and including a plurality of depressions and teeth formed on an outer peripheral portion of said projection,
a ball slid ably received in said aperture of said shank, and engageable into either of said depressions of said driving member,
a button slid ably received in said orifice of said shank, and including an outer end extendible out of said orifice of said shank, and including an inner end received in said orifice of said shank, and including a middle portion having an annular groove formed therein to selectively receive said ball and to allow said ball to be disengaged from said depressions and said teeth of said driving member, and means for biasing said outer end of said button out of said orifice of said shank, and simultaneously to disengage said ball from said annular groove of said button, and simultaneously to force said inner end of said button to engage with said ball, and to force said ball to engage into either of said depressions of said driving member, and to lock said driving member to said shank at selected angular positions.

2. The tool as claimed in claim 1, wherein said button includes an inclined peripheral surface formed in said inner end thereof, and located beside said annular groove thereof, to facilitate a movement of said ball from said annular groove of said button onto said inner end of said button.

3. The tool as claimed in claim 1, wherein said shank includes a peripheral shoulder formed in said orifice thereof, said button includes a peripheral flange extended radially out from said inner end thereof, to engage with said annular shoulder of said shank, and to limit a movement of said button relative to said shank, and to prevent said button from being disengaged from said shank.

4. The tool as claimed in claim 1, wherein said shank includes an end cap to enclose a first end of said orifice of said shank, and said biasing means includes a spring member biased between said end cap of said shank and said button, to bias said outer end of said button out of said orifice of said shank.

5. The tool as claimed in claim 4, wherein said spring member includes a first end having a greater diameter and engaged with said end cap of said shank, and a second end having a smaller diameter and engaged with said button.

6. The tool as claimed in claim 4, wherein said button includes a cavity formed in said inner end thereof to partially receive said spring member.
